(19) United States
(12) Patent Application Publication
(10) Pub. No.: US 2024/0076832 A1
(43) Pub. Date: Mar. 7, 2024

(54) KNEADER MIXER FOR PROCESSING A TRANSFER MIXTURE INTO A MOULDING SOLUTION ACCORDING TO THE DIRECT DISSOLVING METHOD

(71) Applicant: List Technology AG, Arisdorf (CH)

(72) Inventors: Manuel Steiner, Basel (CH); Roland Kunkel, Frankfurt a.M. (DE); Daniel Witte, Grenzach-Wyhlen (DE); Judith Andrea Michelle Günther, Lörrach (DE)

(73) Assignee: List Technology AG, Arisdorf (CH)

(21) Appl. No.: 18/272,195

(22) PCT Filed: Jan. 12, 2022
(86) PCT No.: PCT/EP2022/050476

§ 371 Date: Jul. 13, 2023

(30) Foreign Application Priority Data
Jan. 13, 2021 (DE) 10 2021 100 480.2

(51) Int. Cl. D21C 9/18; B01D 1/22

(52) U.S. Cl. CPC D21C 9/18; B01D 1/226

(57) ABSTRACT

Mixing kneader for processing a transfer mixture into a molding solution, according to the direct dissolution method, having a feed, a housing and a discharge, wherein the feed introduces a product consisting essentially of cellulose, water and a functional liquid into the housing, wherein a kneader shaft situated in the housing rotationally mixes and kneads the product and sweeps wipes it over heated inner surfaces of the mixing kneader, wherein reducing the amount of undissolved particles in the product and the size of the particles are reduced, and evaporating some of the water evaporates to produce form a molding solution, wherein the process volume of the mixing kneader is determined only by the requirements of a molding solution flow capacity.

### BACKGROUND OF THE INVENTION

The invention relates to a mixing kneader for processing a transfer mixture to a molding solution by the direct dissolution method.

The method for the production of a molding solution from pulp by the direct dissolution method on an industrial scale by evaporation of water from a cellulose-water-functional liquid mixture (hereinafter also referred to as product and cellulose, functional liquid and water as product components) is described, for example, in WO 1994/006530 A1, wherein N-Methylmorpholine-N-Oxide (hereinafter also referred to as NMMO or also amine oxide) is used as the functional liquid and the method is also known as the amine oxide method when NMMO is used as the functional liquid. By cellulose-water-functional liquid mixture or product means all water contents or substance mixture states, i.e. from a large water content at which a suspension is present to such a small water content that a molding solution is present, and thus includes the starting material and the transfer mixture, as described in more detail below. A molding solution is described in more detail, for example, in the DE 10 2012 103 296 A1.

A wide variety of pulps are used in the industry for the production of a molding solution from pulp by the direct dissolution method. These differ, for example, in their origin and the nature of their pretreatment. In the following, the pretreatment of cellulose includes all process steps prior to the feeding into the direct dissolution process, which starts with the evaporation of the volatile mixture component (in this case water). These steps usually serve to adjust the dissolution properties or to shorten the dissolution time in the subsequent process steps. The pretreatment comprises process steps known to the skilled person, such as enzymatic pretreatment, grinding of the cellulose or a swelling process.

The WO 1994/006530 A1 describes the use of thin film evaporators for the evaporation of water from a cellulose NMMO-water mixture, which is widely used today for the direct dissolution method, and which are now known and in common use in a variety of forms and designs, all of which are characterized by the fact that an evaporator shaft in the housing of the thin film evaporator distributes the product on inner housing surfaces serving as heating surface, so that a thin film is formed which, if necessary, can additionally be turbulent with increasing rotational speed and decreasing viscosity, so that the product is heated quickly and some of the water evaporates. By heating surface is meant, both above and in the following, any heated surface which is intended to exchange energy thermally over a temperature difference between the heating surface and the product.

While thin film evaporators are mostly designed with a vertical orientation of the evaporator shaft as described for example in WO 1994/006530 A1, they can also be designed with a horizontal orientation of the evaporator shaft as described for example in WO2020/249705A1.

The skilled person is also familiar with the method for the production of a molding solution from cellulose by the direct dissolution method, in which an ionic liquid (hereinafter referred to as IL) is used as the functional liquid instead of NMMO, but otherwise a molding solution is also produced by a direct dissolution method by evaporating water from a cellulose-IL-water mixture.

IL or ionic liquids refers here to a group of organic compounds which, despite their ionic structure, have a low melting point (<100° C.) and are therefore also referred to as molten salts. The use of IL as a functional liquid thus always means an embodiment within the group of ionic liquids that is suitable for the direct dissolution method.

It is known to the skilled person that some ILs tend to decompose thermally at elevated temperatures, so that processes involving a heated IL must keep the temperature of the IL below its decomposition temperature. As an example, the decomposition of the IL [DBNH][OAc] above temperatures of about 100° C. may be mentioned. It is also known to the skilled person that with the reduction of the water content of an NMMO-water mixture at elevated temperatures, decomposition of the NMMO begins. At temperatures typically above 140° C., there is an increasing risk of explosion with reduction of the water content, for example through explosive autocatalytic decomposition, from which a further increase in temperature and thus an acute risk of explosion follows. Depending on the composition of the mixture, decomposition can also be observed from temperatures above 125° C., since the decomposition temperature can be reduced by, for example, the presence of reducing agents (such as cellulose) and heavy metal ions (such as iron ions). In the case of the direct dissolution method described, a reduction in the decomposition temperature can be expected due to the presence of cellulose in accordance with the process and the use of ferrous materials for the machine construction, despite stabilizers usually being added.

The skilled person is also aware of the fact, referred to in the context of the invention as the problem of substantial overheating, that in order to avoid decomposition of the functional liquid, great attention must be paid to controlling the temperature of the product (hereinafter also referred to as the product temperature). Therefore, it chooses a process in which the desired temperature of the product as well as its equilibrium temperature is below the decomposition temperature.

In the case of a multi-component mixture, as is present in the case of the cellulose-functional liquid-water mixture, each composition of the mixture is assigned an equilibrium temperature at the prevailing process conditions (pressure) at which the mixture begins to boil. If energy is supplied to the system, some of the volatile components (in this case water) evaporate. At the same time, the composition of the mixture changes, as a result of which the equilibrium temperature also changes. Thus, the mixture heats up when energy is supplied, while its composition changes along its equilibrium curve due to evaporation of volatile components. As the water content decreases, the viscosity increases and the dissolving power of the functional liquid or functional liquid-water mixture increases. As the viscosity increases, the evaporating water in the product increasingly runs the risk of transport limitation, so that evaporative cooling can no longer take place to a sufficient extent and consequently the temperature of the water-functional liquid mixture and of the product increases to values above the equilibrium temperature. The equilibrium temperature of the mixture changes with its composition as well as with the process pressure. Thus, the temperature of the mixture increases over the course of the process even without transport limiting effects, so that it is possible for decomposition to occur even at equilibrium temperature if the process parameters are chosen appropriately. The skilled person therefore selects process parameters where the equilibrium temperatures that occur are always below the decomposition temperatures. For NMMO as a functional liquid, equilibrium temperatures in the area of 50° C. to 110° C. usually result over the course of the process as an example.

In the case of NMMO as a functional liquid, exothermic decomposition processes also lead to local material overheating (hot spots) if transport is limited, from which the heat of reaction cannot be dissipated to a sufficient extent. This subsequently triggers further exothermic decomposition processes.

Significant overheating causes the functional liquid, the cellulose or the cellulose-functional liquid-water mixture to heat to such high temperatures at which their decomposition occurs. Overheating, which results in temperatures of the product or a product component above the decomposition temperatures specific to the product or product component is referred to in the following as having substantial overheating. It is irrelevant thereby whether the superheating results from insufficient evaporative cooling through transport limitation or is caused by overdrying of the product at equilibrium.

The decomposition of the functional liquid is described above. On the one hand, it causes the need to replace the lost—usually very expensive—functional liquid and, on the other hand, acutely increases the risk of explosion when NMMO is used as the functional liquid.

However, substantial overheating may also involve decomposition of the cellulose or the cellulose-functional liquid-water mixture (or, by definition, the product) by leading to a reduction in the degree of polymerization (known to the skilled person as DP) of the cellulose at excessively high temperatures, possibly in conjunction with increased shear—typically prevalent at elevated viscosities. Thus, a substantial overheating of the product can have a product-damaging or safety-hazardous effect by decomposing parts of the product or the product itself.

Of course, a process management at temperatures below the decomposition temperature can also have a damaging or safety-endangering effect on the product due to non-thermally induced decomposition processes (e.g. radical reactions). In practice, however, common stabilizers counteract this.

Furthermore, a temperature control aiming at equilibrium temperatures above the decomposition temperatures would also lead to product damage and safety hazards. In practice, the skilled person does not aim for such a mode of operation.

Nevertheless, when using a thin film evaporator for the direct dissolution method, special attention must be paid to temperature control due to its apparatus-specific properties. On the one hand, a characteristically high heat input with a small amount of product present in the apparatus leads to efficient evaporation of volatile components. On the other hand, process fluctuations that occur (e.g. supplied mixture flow rate, energy input or product viscosity) can only be absorbed to a limited extent due to the small amount of product in the apparatus. Thus, a slight reduction in the supplied mixture flow rate can already lead to a significant increase in the product temperature. This involves the risk of a temperature increase into areas above the decomposition temperature.

The skilled person knows that dissolution processes are not instantaneous but occur within a period of time at a dissolution rate and require a minimum dissolution time. It is also known to the skilled person that dissolution rates are influenced by various factors such as temperature, and in the case of the direct dissolution method described, that in addition to temperature, the concentration of the functional liquid and the mechanical treatment of the mixture also have an influence on the dissolution rate. Thus, for the same composition and the same temperature, different dissolution states can occur as a result of different mechanical treatment of the material for the same treatment time.

Thus, in addition to water evaporation for the production of a molding solution, mechanical action on the product is also necessary which is achieved by the specifically selected geometry of a mixing element and which must take place over a certain period of time.

When using a thin film evaporator, an unscheduled stop of the discharge pump, either as a result of an interruption of the entire production plant containing, among other things, the process, as a result of a malfunction of one of the numerous process organs following the process, or whether as a result of a malfunction of the components used in the process itself, can quickly overheat the molding solution accumulating in front of the pump due to its high viscosity as a result of mechanical energy input if the evaporator shaft. This represents an acute risk of product damage and, in the case of NMMO, an explosion risk in particular. If the rotation of the evaporator shaft is stopped, the product distributed as a thin film in close contact with the heated inner housing surfaces can quickly overheat, which is also an acute product damage and, in particular, explosion risk. The heated housing surfaces are referred to as heating surfaces in the context of the invention.

A further disadvantage known to the skilled person is that, in order to avoid significant overheating of the product or the functional liquid, the temperature of the heating surface (also referred to as the heating temperature or heating surface temperature) is greatly reduced in the discharge-side area of the thin film evaporator. The higher product viscosities present there also result in a higher energy input by dissipation compared to the upper area of the thin film evaporator. In addition, the transport speed of the product is reduced by the accumulation effect in front of the discharge, which increases the time available for product heating, which not only increases the energy input by dissipation but also the thermal energy input.

Therefore, in order to avoid significant overheating of the product, it is necessary to lower the heating temperature relative to the upper area. The temperature of the heating surface is typically lowered to such an extent that it corresponds approximately to the temperature of the molding solution (hereinafter also referred to as the molding solution temperature) as it exits the thin film evaporator, i.e., in the case of NMMO as functional liquid, at typically 100 to 105° C., in order to merely temper the product. Depending on the water content in the starting material, the zone in the discharge side area with reduced heating temperature typically affects 20% to 50% of the heating surface of the thin film evaporator. Conversely, avoiding this reduction in heating temperature would mean an increase in the area of the thin film evaporator used for thermal energy input by 25% to 100%, the latter would therefore mean a doubling.

The purpose of reducing the heating surface temperature is to compensate for this mechanical energy input in particular, in order to avoid significant overheating of the product or product components and the associated risks of product damage and decomposition.

The reduction of the temperature of the heating surface to avoid significant overheating has a disadvantage for all functional fluids, NMMO or an IL, that not all of the available heating surface can be used for thermal energy input which, in view of the limited sizes of thin film evaporators, means that this heating temperature reduction reduces the maximum production capacity of a production line, which is of crucial importance in a cost-sensitive industry that competes, among other things, on economies of scale.

Another disadvantage is the increase in energy costs due to the above-mentioned reduction in thermal energy input in favor of mechanical energy input, since instead of typically cost-effective thermal energy input over the heating surface, there is typically expensive electromechanical energy input via energy dissipation of the rotating evaporator shaft of the thin film evaporator.

The reduction in heating temperature can also even result in a dissipation of heat from the product in the discharge side area of the thin film evaporator, which is a heat loss and further increases energy costs.

In the case of NMMO as a functional liquid, common to all the above methods of production of a molding solution by evaporating water from a cellulose-NMMO-water mixture is the risk of explosion.

To the skilled person, therefore, the use of a thin film evaporator for the production of a molding solution is also inherently disadvantageous because, in particular, its evaporator shaft is used for two process tasks: On the one hand, it is to produce a low-viscosity thin film for evaporation in the upper zone and, on the other hand, the same evaporator shaft, i.e. with the same rotational speed, is to mix an accumulated high-viscosity temperature-sensitive mass in the discharge side zone for the purpose of dissolving it to form a molding solution. If the rotational speed of the evaporator shaft has to be set and controlled for optimum evaporation this also changes the process conditions for dissolving in the zone on the discharge side. Consequently, the two process tasks cannot be optimized independently of each other in this case, which can have a detrimental effect on overall efficiency, process flexibility and product quality.

This problem is now to be solved by the WO 2013/156489 A1, which discloses two successive devices for evaporating water, wherein the first is a thin film evaporator and the second is a thick film evaporator, preferably a kneader reactor as described in the DE 199 40 521 A1, wherein in the following the kneader reactor is called a mixing kneader. The mixing kneader can, thanks to good high-viscosity mixing properties and effective mechanical energy input over its shaft (hereinafter referred to as kneader shaft), the speed of which can be quickly set and also quickly reduced again, control the temperature with great accuracy and reliably and, as a rule, avoid cooling of the product or heat dissipation. The thin film evaporator and the mixing kneader are directly connected to each other by a link, but the WO 2013/156489 A1 is silent over the explicit embodiment of the link.

The water content in the NMMO of the concentrated pulp suspension is divided into three sections during the dissolution process. After the first section, the pulp suspension is discharged from the thin film evaporator and fed into the mixing kneader. The first section shows no increase in viscosity and ends with the beginning of the dissolving window, which corresponds to a 2.5 hydrate, which corresponds to an NMMO-water concentration (NMMO related to NMMO and water in mass fractions) of approx. 72.2 wt % and where—as in WO 06/33302 A—a low tendency to explosion is expected due to the high water content. The second section consists of the main dissolution process, so that there the viscosity starts to increase strongly, and the associated necessary evaporation of water until about a 1.5 hydrate is formed, which corresponds to an NMMO water concentration of about 81.3 wt %. In the third section, the homogenization takes place and water evaporates until a 0.8 to 1.0 hydrate (monohydrate) is formed, which corresponds to an NMMO water concentration of respectively approx. 89.1 wt % to 86.7 wt %.

Although the thin film evaporator in this method only has the process task of evaporation, the disadvantage of this method is the still high water content, which is not evaporated by a thin film evaporator. This corresponds to an unused process efficiency potential of the thin film evaporator. Moreover, in the case of a cellulose-water-NMMO mixture in which the NMMO water amount is still present as 2.5 hydrate, a subsequent mixing kneader in the input zone—as described in the WO 2013/156489 A1—still has to evaporate a large amount of water. Consequently, the two process tasks of evaporation and dissolution now fall to the mixing kneader. Since, also in the case of the mixing kneader, each kneader shaft can only have one rotational speed, this can lead, as in the case of the thin film evaporator, to the disadvantages already mentioned. For example, a high speed to be selected for the evaporation task can lead to product degradation in the dissolution task due to increased shearing or temperature damage.

In order to achieve economical sizes of the mixing kneader, this also has the consequence that, in addition to the mechanical energy input by kneading action, a non-negligible amount of the energy to be input must be provided by contact heat. Consequently, it is necessary to maximize the heating surface at least in the input zone, which means that the discs attached to the kneader shaft, as described in more detail below, to which the mixing bars are attached, must also be designed so that they can be heated. On the one hand, this heating increases the costs in design and production as well as the production time of the mixing kneaders and, on the other hand, leads to higher construction weights of the kneader shaft. The integrated heating system also lowers the mechanical stability of the design and consequently causes a reduction in the maximum sizes of the mixing kneaders. The necessity of this design is further reinforced by the low viscosity of the concentrated pulp suspension when entering the mixing kneader with a NMMO water concentration of about 72.2 wt %, since this results in insufficient torque and speed in the input zone of the subsequent mixing kneader to already ensure sufficient water evaporation through the resulting friction and heating of the pulp suspension. In order to ensure sufficient process flexibility and process control, it is also necessary to provide various heating zones that are separated from each other and can be operated at different temperature levels in order to react to any process changes. The number of zones increases the flexibility of the system and consequently the possibility of process control. However, this is also accompanied by an increase in the design and manufacturing effort, which ultimately leads to an increase in costs.

Additionally disadvantageously, the high proportion of water to be evaporated in the invention disclosed in the WO 2013/156489 A1 means such a high requirement for heating surfaces in the mixing kneader that the mixing kneader must be designed essentially according to the heating surface requirement (in technical jargon, a “surface scale up”). Thereby, the size of the mixing kneader is mainly determined by the fact that it has the required heating surface for water evaporation. The high water content at the entrance of the mixing kneader means not only a large amount of water to be evaporated but also a low viscosity, which means a lot of thermal energy input over heated surfaces, because the viscosity required for mechanical energy input is too low in the highly water-containing mixture. This is particularly important for industrial implementation. This is because the surface-to-volume ratios, which typically decrease with increasing size in apparatus engineering, lead with large capacities to relatively increasingly large and consequently increasingly expensive sizes. Although it is possible to compensate for the decreasing surface-to-volume ratios with large sizes by installing additional thermal exchange surfaces, e.g. by fitting additional heated disks to the kneader shaft, this results in higher costs for design and production and thus also reduces the economic efficiency of the plant.

In summary, the high water content means on the one hand a high evaporation load for the mixing kneader and on the other hand, due to low viscosity, a low amount of mechanical energy input with considerable economic disadvantages in the industrial implementation.

Mixing kneaders are known to the skilled person. They preferably have exactly one or exactly two kneader shafts, which are used to execute highly viscous and encrusting processes, which can be operated under vacuum, atmospheric or overpressure and which can be heated or cooled via thermal exchange surfaces. In addition, at typically present product viscosities, the kneader shaft and its shaft structures can heat the product very effectively by rotation and resulting energy dissipation.

If there is exactly one kneader shaft, a single-shaft mixing kneader is present in front of it, which is described, for example, in the CH 674 472 A5. In this case, the shaft structures of the kneader shaft preferably mesh during operation with static structures of the housing, for example so-called counter hooks. If exactly two kneader shafts are present, a twin-shaft mixing kneader is present, which is described for example in the DE 41 18 884 A1. The shaft structures of the kneader shafts preferably mesh with each other during operation.

The at least one kneader shaft comprises shaft assemblies in the form of disks and bars attached thereto, wherein the shaft assemblies of the at least one kneader shaft are arranged to mesh in operation with the shaft assemblies of a second kneader shaft or with stationary counter elements present in the mixing kneader. Mixing kneaders with such meshing elements are known and referred to as “self-cleaning” because the described meshing removes any buildup from the meshing elements.

The kneader shafts with disks and bars described above are known from the prior art, for example the DE 41 18 884 A1. For the present invention, it is irrelevant in which way the bars are attached to the discs and these in turn to the kneader shafts. For example, bars and discs (also called “supports”) can also be manufactured in one piece, so the term “fixed” must be interpreted broadly. While the aforementioned DE 41 18 884 A1 shows a twin-shaft mixing kneader, the CH 674 472 A5 shows a single-shaft mixing kneader with hook-like static kneading counter elements (so-called “kneading counter hooks”) on the inner wall of the housing. The housing, kneader shaft(s), shaft structures and static kneading counter elements can be designed as described in the above-mentioned publications.

The inner sides of the mixing kneader housing, the kneader shaft(s) and the disks can be designed as non-exhaustive thermal exchange surfaces. In the case of the mixing kneader housing, thermal exchange surfaces are typically in the form of welded-on half-tubes or, preferably, double walls. In the case of the kneader shafts, thermal exchange surfaces mean that the kneader shaft is designed as a hollow shaft and preferably has an inflow and a return flow of the heat transfer medium or cooling medium, for example with an inner tube.

Discs with thermal exchange surfaces have cavities or bores for electrical heating elements or a heat transfer medium or cooling medium, the latter having an inflow that is fed from the inflow in the kneader shaft and an outflow that flows back to the return flow in the kneader shaft. The cavities can typically be designed as double walls or bores and require greater wall thicknesses and larger dimensions of the shaft structures and kneader shaft with thicker walls and cause a significantly greater manufacturing effort compared to cavity-free (hereinafter also referred to as heating cavity-free) discs, which typically due to the omission of thermal exchange surfaces can be built smaller and easier.

### SUMMARY OF THE INVENTION

The object of the present invention is to overcome the disadvantages of the prior art.

In particular, a kneading mixer for processing a transfer mixture is to be described, which primarily makes it possible to reduce the sizes of the mixing kneader and thereby improve the product quality and process control.

The features disclosed herein lead to the solution of the object.

Advantageous embodiments are also described herein and in the dependent claims.

The object of the present invention is a mixing kneader for processing a transfer mixture as the last process stage of an at least two-stage process according to the direct dissolution method in a mixing kneader, which takes into account all the facts mentioned in the context of the object.

The last process stage is defined by the fact that in this last process stage a molding solution is produced from the transfer mixture. Independent of this and not to be designated as process stage within the scope of the invention are, for example, a subsequent discharge unit and then further intermediate pumps and buffer tanks or the like, which are still necessary until spinning/shaping. The processing of the transfer mixture to a molding solution thereby consists on the one hand of a dissolution process. This requires a certain amount of time for a certain mixing and kneading intensity (determined in particular by the specific design of the mixing kneader and the rotational speed of the kneader shaft) for a certain product (determined in particular by the type and amount of cellulose and functional liquid). Ultimately, this part of the process results in a mold solution flow—which can subsequently be fed to a forming operation. Since the design is time-determined, the process volume of the mixing kneader is essentially directly proportional to the capacity of the mold solution flow (also called molding solution flow capacity). This is in contrast to the surface scale-up known to the skilled person.

In addition, the processing of the transfer mixture to a molding solution also consists of the evaporation of the water remaining in the transfer mixture to the amount required for the dissolution process and the molding solution. However, this evaporation task is subordinate to the dissolution task of the mixing kneader and does not determine its size. For this evaporation, the mixing kneader requires, in addition to the mechanical energy input resulting from viscosity in combination with a process volume and with at least one rotating kneader shaft, heating surfaces for a thermal energy input, which are situated in the mixing kneader.

Thus, the capacity of the mixing kneader means an evaporation capacity on the one hand and a molding solution flow capacity on the other hand.

The mixing kneader according to the invention makes use of the so far unknown knowledge that mixing kneaders above a certain water content in the transfer mixture can no longer be executed with a smaller process volume, because from this water content onwards, the process volume required for the dissolution time must be applied—i.e. the molding solution flow capacity is decisive for the design. Conversely, this means that as the water content in the transfer mixture increases above a certain water content, the mixing kneader must be built larger than would be required for the molding solution flow capacity, because the evaporation capacity requires a larger design in order to arrange corresponding heating surfaces in the mixing kneader.

Therefore, the mixing kneader according to the invention consists of a mixing kneader whose size exclusively fulfills molding solution flow capacity.

The evaporation capacity of the preceding processing organ for producing the transfer mixture by evaporation of essentially water (hereinafter referred to as main evaporation) is adapted accordingly and results from the heating surfaces and the viscosity-dependent mechanical energy input capacity of the mixing kneader. It is also provided within the scope of the invention that the transfer mixture is produced from a starting material in several preceding processing organs. These preceding processing organs can thereby be connected in series or in parallel.

The mixing kneader according to the invention for processing the transfer mixture to a molding solution according to the direct dissolution method is a mixing kneader with a feed, a housing, at least one kneader shaft rotating in the housing and a discharge, wherein the feed introduces a product in the form of the transfer mixture essentially of cellulose, water and a functional liquid into the housing, wherein the transfer mixture is agitated until some of the water has evaporated to form the molding solution, wherein the molding solution flows to the discharge with a supply stream, and then to the subsequent processing organ, such as the discharge screw, the transfer pump, the buffer tank, the spinning pump and the spinneret.

In this case, the product is to be fed into the mixing kneader in the form of a transfer mixture and not a suspension.

The practice with mixing kneader types used so far by the inventors for the direct dissolution method of the mold dissolution process according to the invention has shown that the residence time in the mixing kneader can be reduced to a range between 2 and 15 minutes, wherein the residence time is largely determined by the dissolution time of the cellulose and the exact dissolution time depends, for example, on the cellulose concentration, the cellulose type, its pretreatment, the main evaporation and the type of functional liquid, and can also go beyond these areas. This corresponds to a significant reduction in the residence time of the product in the mixing kneader relative to the prior art, which means that the mixing kneader can accordingly also be built much smaller, as illustrated by the following example: even with a comparatively low industrial production capacity of for example 6.4 kta cellulose, feeding the mixture with a concentration corresponding to a 2.5-hydrate, as disclosed in the WO 2013/156489 A1, results in a construction size of the mixing kneader of 14,000 L. This is equivalent to a residence time of the product in the mixing kneader of about one hour. The same production capacity can be achieved with a mixing kneader volume of 2 500 L at the same process pressure, wherein heating of the kneader shaft disks and division into several temperature zones can be dispensed with, provided that the product is introduced into the mixing kneader at a concentration corresponding to a 1.3 hydrate. This corresponds to a reduction in the process volume of more than 80% and a reduction in the residence time to about 12 minutes.

The transfer mixture is thereby characterized by a water content at which the temperature of the heating surface of the thin film evaporator—especially towards the discharge—is not significantly reduced compared to the feed, without any significant overheating of the product. The transfer mixture differs from the molding solution in that it corresponds to the product in a state before it is transferred to a moldable or spinnable solution (i.e., a molding solution). A moldable or spinnable solution is present when all essential cellulosic components of the starting material have dissolved. In this context, substantial means such a small amount of non-dissolved components that the so-called filter lives reach an economically acceptable level.

A filter life refers to filters that are typically used after the molding solution production process stage and before the molding or spinning process stage. The filter life corresponds to the length of time or useful life until a filter must be replaced because the pressure drop across the filter becomes too high, which increases due to the accumulation of components that are undesirable for further processing. These components can be, for example, undissolved cellulosic fibers as well as non-cellulosic contaminants. The specific choice of a filter service life is therefore subject to overall economic costs and quality-optimizing aspects.

The transfer mixture also differs from the starting material in that some of the cellulose present in the starting material is already in solution in the transfer mixture as a result of thermomechanical treatment in the thin film evaporator.

The mixing kneader according to the invention for processing the transfer mixture to a molding solution in a mixing kneader is characterized in that the product in the mixing kneader has the smallest possible water content, which corresponds to the water content which still has to be evaporated during the dissolution time, which has the advantage that the mixing kneader can be built as small as possible and ideally not all surfaces have to be heated.

This leads to an optimal use of the mixing kneader, since its strength is kneading. In particular, this is also advantageous because the strength of the thin film evaporator, namely evaporation, is also used at the same time.

Conversely, this means that the input concentration of water into the mixing kneader is adjusted with the aid of the upstream evaporator stage, so that a minimum apparatus volume of the mixing kneader results. According to the invention, the evaporator capacity of the thin film reactor is adjusted, e.g. with the aid of the heating temperature of the thin film reactor, in such a way that the desired composition of the molding solution is obtained at the discharge of the mixing kneader with the maximum possible throughput of the mixing kneader and compliance with a minimum necessary dissolution time. In terms of equipment, this means a reduction in particle entrainments by reducing the gas velocities or that the cross-sectional area of the housing openings discharging the vapor stream can be made smaller, ideally combined with a reduction in the number of housing openings from, for example, two to one. In terms of equipment, this also means that the discs can be designed only without heating cavities or also as pure supports with a minimized side surface, which reduces the load on the kneader shaft and simplifies its production. In addition, this means a uniform load on the kneader shaft, which generally leads to a longer service life of the mixing kneader, among other things.

As an additional optimized process variant, according to the invention, the heating power of the thin film reactor is adjusted so that exactly enough mechanical power of the mixing kneader is introduced into the product that contact cooling in the mixing kneader is not necessary for a safe and energy-efficient method. This simplifies the process control and, especially when NMMO is used as the functional liquid, increases the process reliability of the method. In addition, the process variant described brings the advantage of a minimal thermal stress on the mixture in the mixing kneader, which is beneficial to the product quality of the molding solution. In terms of equipment, this means that the kneader shaft does not need to have several heating/cooling zones. Preferably, there is no contact cooling in the mixing kneader. In the present invention, the shaft structures can preferably be designed without heating cavities and the energy input introduced by kneading is sufficient to produce a molding solution from the transfer mixture. This is also possible because the preceding processing unit in the form of the thin film evaporator removes so much water during the production of the transfer mixture that the object of the mixing kneader is no longer the previously essential evaporation of water, but the kneading of the transfer mixture to form the molding solution.

The evaporation capacity of the preceding processing organ is thus adjusted in such a way that the process energy required for heating and evaporating the mixture in the mixing kneader preferably results only from the mechanical power of the mixing kneader.

This increases both the maximum molding solution flow capacity per mixing kneader as the last processing organ in a multi-stage direct dissolution method and thus the maximum production capacity per production line.

Also advantageous herein is the increased energy efficiency and process reliability in combination with a suitable preceding processing organ such as preferably a thin film evaporator for the entire transfer of a starting material into a molding solution.

According to the invention, an IL or NMMO is added as a functional liquid for the starting material. The functional liquid serves to dissolve the cellulose under appropriate conditions.

In the aforementioned combination with a preceding processing organ for producing a transfer mixture, a preferred embodiment of the mixing kneader is characterized in that it is designed to process a transfer mixture selected so that the viscosity of the transfer mixture is not only low enough to avoid substantial overheating in the thin film evaporator, but is also high enough that the mechanical energy input by friction in the mixing kneader is so high that the need for thermal energy input—supplementing the mechanical energy input—into the mixing kneader is so low that the kneader shaft superstructures do not have to serve for thermal heat exchange, but can be designed without heating cavities. This enables a significantly simpler, more favorable and faster kneader shaft design.

The transfer mixture processed in the mixing kneader according to the invention to form a molding solution is therefore selected so that, for certain process conditions, essentially mixing and kneading intensity, degree of filling, gas pressure and heating temperature, as well as for a certain type of and a certain amount of cellulose and type of pretreatment thereof and a certain type and amount of a functional liquid, it has a water concentration such that at least one of the following conditions is fulfilled or at least one of the following embodiments according to the invention is given:
(1) The size of the mixing kneader is designed exclusively to meet the requirements of a molding solution flow capacity, and the thereby resulting water evaporation capacity of the mixing kneader corresponds to the water evaporation capacity necessary to be able to evaporate the water portion of the transfer mixture required for the production of a molding solution. Conversely, this means that the mixing kneader is designed in such a way that a reduction of the water content in the transfer mixture or an increase in the evaporation capacity of the mixing kneader by, for example, higher heating temperatures does not result in the molding solution flow capacity being increased.
(2) In the case of NMMO as a functional liquid, the water content of the transfer mixture generally meets the following conditions:

maximum x_{H2O}=−0.235x_{Cell}+0.235

minimum x_{H2O}=−0.59x_{Cell}+0.2047.
Even more preferably, the transfer mixture is applied at the preferred composition of

maximum x_{H2O}=0.2864x²_{Cell}−0.6786x_{cell}+0.2288

minimum x_{H2O}=0.2864x²_{Cell}−0.6786x_{Cell}+0.2188.

Preferably, the transfer mixture is selected in such a way that—in addition to (1) and (2) above—it has a water concentration such that in addition:
(3) the mixing kneader is equipped with at least one kneader shaft, the superstructure of which does not have to be heatable, and the transfer mixture has sufficient viscosity to achieve the evaporation rate required in the mixing kneader for the production of a molding solution by means of mechanical energy input, in addition to thermal energy input via a heatable kneader shaft of the mixing kneader and a heatable housing of the mixing kneader.

In a preceding process step, the starting material is presented as a mixture of cellulose, water and functional liquid, the composition of which can vary greatly.

The starting material thereby becomes a transfer mixture in the preceding process step. This process step can preferably take place in one or more thin film evaporators. The thin film evaporator(s) is/are thereby the preceding processing organ.

In the transfer mixture according to the invention, the cellulose is present partially dissolved and, in the case of NMMO as a functional liquid, the water content in the NMMO can be taken from the mathematical formula.

The formulas describing the transfer mixture refer to the production of a transfer mixture under thermomechanical conditions that allow low-risk operation of a thin film evaporator and have been proven in practice. However, due to the explained influences on the dissolution rate of the cellulose, it is possible that the formula predicts a spinnable solution, while in practice a transfer mixture according to the invention with undissolved cellulosic components is still present despite low water contents, because a special thermomechanical treatment has been chosen, such as very short times of the product between feed and outlet. However, such thermomechanical treatments are at the same time associated with an increased process risk due to substantial overheating and explosive decomposition because of the associated lower water content in the transfer mixture.

Furthermore, according to the invention, this can also mean that the starting material is fed to the preceding process step, which describes the general transfer mixture, even in the case of compositions within the concentration range. Usually, only the process-specific thermomechanical treatment of the starting material (increased temperature and shearing action) results in a transfer mixture characterized by a partial dissolution of the pulp.

The transfer mixture is then further processed into a molding solution in a mixing kneader, which is more suitable for reliable transfer of the transfer mixture into a molding solution than the preceding processing organ, such as a thin-film evaporator, since the mixing kneader, as described above, can regulate the temperature with great accuracy and safety, in particular thanks to good high viscosity properties and effective mechanical energy input over the kneader shaft, the speed of which can be quickly adjusted and also quickly reduced again, and usually avoids cooling or heat dissipation.

In another embodiment, the transfer mixture first passes through a transfer organ or transfer organs subsequent to the thin film evaporator or the multiple thin film evaporators before being fed into the mixing kneader.

Thus, the increased energy efficiency and process reliability applies not only to the process step of producing the molding solution from the transfer mixture in the mixing kneader, but also in combination with a suitable preceding processing unit for the entire transfer of a starting material into a molding solution.

The material properties using the formulas listed above to describe the general transfer range result from the following investigations. The maximum water content x_{H2O} describes the composition which corresponds to the di-hydrate when water and NMMO are considered. NMMO molecules have the ability to form two hydrogen bonds. The hydrogen bonds lead, on the one hand, to the formation of structures with water molecules bonded over them and, on the other hand, to the dissolution of cellulose molecules. From a ratio of less than two water molecules per NMMO molecule, there is thus theoretically a solubility of the NMMO for cellulose molecules. This separates the transfer mixture from the pure suspension as an upper water content limit. For example, it is also described in the literature that with appropriate thermomechanical treatment, some cellulose is already in solution at NMMO water concentrations of about 75%.

For the skilled person, the minimum water content x_{H2O} describes, based on the U.S. Pat. No. 4,196,282 A, the composition at which, after visual examination, complete dissolution of the cellulose in the cellulose-water-NMMO mixture could be observed for the first time. It thus delimits the transfer mixture from the complete molding solution. The statements made in the U.S. Pat. No. 4,196,282 A with respect to NMMO as a functional liquid are confirmed by results and observations from industrial applications and experiments carried out by the inventors on a pilot plant scale. Consequently, the two formulas presented encompass the area of the general transfer mixture.

For the description of the material properties of the preferred transfer range, reference is to be made to the U.S. Pat. No. 4,196,282 A with regard to the minimum water content. Based on this, the curve describes the 95% confidence interval of the minimum water content of the general transfer range and thus further differentiates itself from the safe state of a complete molding solution. The formula for describing the maximum water content x_{H2O} of the preferred transfer range is based on results from industrial applications of the direct dissolution method and data collected from series of experiments conducted by the inventors on a pilot plant scale. It marks the upper limit of the transfer range within which an optimum utilization of the specific process-relevant mixing kneader characteristics is ensured.

The transfer mixture is in a pre-solution state in its general composition and also in its preferred composition (each described by the corresponding formulas mentioned above). Thus, it has also been achieved that the molding solution process has taken place under optimum operating parameters of the thin film evaporator and that the comparatively difficult material states of the molding solution are avoided when, for example, encrustation occurs in the thin film evaporator or overdrying or decomposition takes place. These difficult material conditions do not lead to problematic process conditions in the subsequent mixing kneader according to the invention, because this is generally designed, for example, for higher torques as well as the avoidance of crust formation.

In the formula describing the general composition, a discharge of the transfer mixture is already advantageous because sufficient water has evaporated so that a transfer mixture is formed and further processing to solution in the subsequent process organ can take place in a relatively short process time.

In the formula describing the preferred composition of the transfer mixture, the maximum amount of water, compared to the definition of the general transfer mixture, is already closer to the complete solution. On the other hand, the minimum amount of water has a greater distance to this complete solution.

In this way, the processing of the transfer mixture into a molding solution in the mixing kneader according to the invention can be realized in a short process time, corresponding at most to the dissolution time, and at the same time the risk of overdrying of the material can be reduced. In both cases of the formula, however, the transfer mixture is two to several minutes of processing time, during which the product is homogenized in the mixing kneader and any remaining water is evaporated, away from a formable or spinnable solution.

The product and thus also the starting material essentially comprise cellulose, water and a functional liquid. In addition, the product contains further chemicals such as stabilizers, etc., the enumeration of which in detail can be dispensed with in the context of the invention, since they are known to the skilled person and require adaptation for each individual case of application.

### BRIEF DESCRIPTION OF THE DRAWINGS

Further advantages, features and details of the invention result from the following description of preferred embodiment and from the drawings; these show in

FIG. 1 a diagram showing the general and preferred material properties of a transfer mixture.

### DETAILED DESCRIPTION

### Example 1

The subject of this example is the production of a molding solution with a cellulose content of 12 wt % using the direct dissolution method. The functional liquid used in this example is NMMO. All subsequent proportions refer to the total mass of the cellulose-NMMO-water mixture. A starting material with a cellulose content of approx. 7.2 wt % is prepared from cellulose and aqueous NMMO solution, resulting in an NMMO content of approx. 46.1 wt %. This starting material is fed into a thin film evaporator at a flow rate of about 417 kg/h, where it is concentrated into a transfer mixture. In the example, the thin film evaporator is operated at a process pressure of 70 mbara, so that the equilibrium temperature of the starting material is approximately 43° C. The heating temperature of the thin film evaporator is 130° C. In the present example, the transfer of the mixture occurs within the preferred transfer range at a cellulose amount of about 11.5 wt % and an NMMO amount of about 73.9 wt %. Under the present process conditions this corresponds to an equilibrium temperature of the transfer mixture of about 100° C. The ratio of water and NMMO at this point corresponds approximately to that of a 1.3 hydrate. The transfer mixture provided by the thin film evaporator is subsequently transferred to the mixing kneader at a flow rate of about 261 kg/h. There, the cellulose is completely dissolved, homogenized and the mixture is finally concentrated by evaporation to give a complete molding solution. The residence time of the mixture in the mixing kneader is 8.5 minutes. The process volume of the kneader is therefore approx. 70 L. The molding solution leaves the mixing kneader with a flow of approx. 217 kg/h with a cellulose amount of 12.0 wt %, an NMMO amount of approx. 77.0 wt % and a temperature of approx. 107° C.

### Example 2

The subject of this example is the production of a molding solution with a cellulose content of 12 wt % using the direct dissolution method. The functional liquid used in this example is an ionic liquid. All subsequent proportions refer to the total mass of the mixture. A starting mixture with a cellulose amount of about 8.2 wt % is prepared from cellulose and aqueous IL solution, resulting in an IL amount of about 58.6 wt %. This starting material is fed into a thin film evaporator at a flow rate of about 475 kg/h, where it is concentrated into a transfer mixture. In the present example, the transfer of the mixture takes place at a cellulose amount of about 11.5 wt % and an IL amount of about 79.6 wt %. The transfer mixture provided by the thin film evaporator is subsequently transferred to the mixing kneader at a flow rate of approx. 347 kg/h. There, the mixture is finally concentrated by evaporation and homogenized to give a complete molding solution. The residence time of the mixture in the mixing kneader is 12 minutes. The process volume of the kneader is therefore approx. 115 L. The molding solution leaves the mixing kneader with a flow rate of approx. 333 kg/h with a cellulose amount of 12.0 wt % and an IL amount of approx. 83.0 wt %.

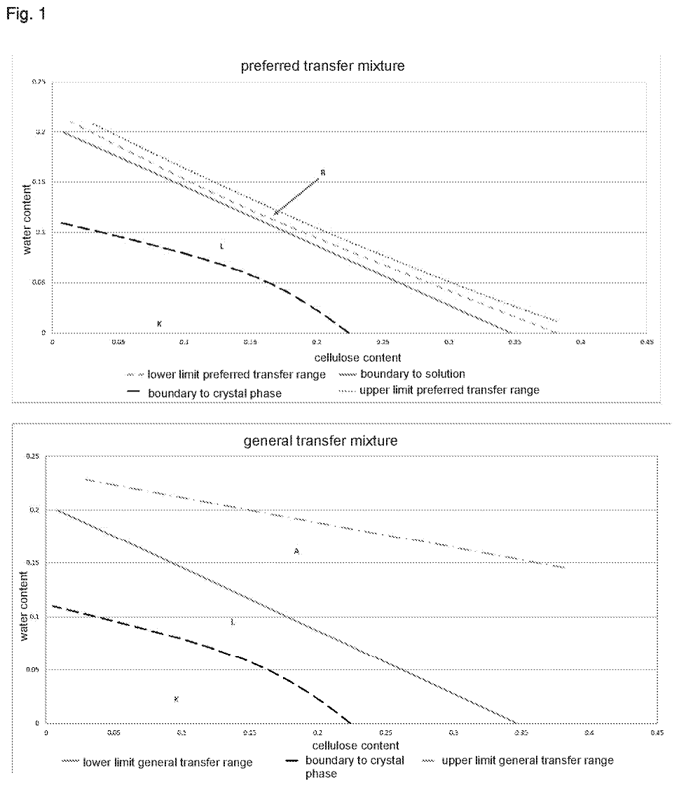

FIG. 1 shows a diagram showing the general and the preferred material composition of the transfer mixture. Thereby the general composition a has the following parameters of

maximum x_{H2O}=−0.235x_{Cell}+0.235

minimum x_{H2O}=−0.59x_{Cell}+0.2047

and thus shows a larger margin than the preferred composition b, which has the following parameters of

maximum x_{H2O}=0.2864x²_{Cell}−0.6786x_{Cell}+0.2288

minimum x_{H2O}=0.2864x²_{Cell}−0.6786x_{Cell}+0.2188.

As the water content decreases, the area of solution L is first reached and as the water content continues to decrease, crystallization K of the NMMO occurs.

Reference list

| | |
|---|---|
| A | General composition of the |
| | tansfer mixture |
| B | Preferred composition of the |
| | tansfer mixture |
| K | Crystallization |
| L | Solution |

1. Mixing kneader for processing a transfer mixture into a molding solution according to a direct dissolution method, comprising a feed, a housing and a discharge, wherein the feed introduces a product consisting essentially of cellulose, water and a functional liquid into the housing, wherein a kneader shaft situated in the housing rotationally mixes and kneads the product and wipes it over heated inner surfaces of the mixing kneader, wherein the amount of undissolved particles in the product and the size of the particles are reduced and some of the water evaporates to form a molding solution,
wherein
the process volume of the mixing kneader is determined only by the requirements of a molding solution flow capacity.

2. Mixing kneader for processing a transfer mixture into a molding solution according to a direct dissolution method, comprising a feed, a housing and a discharge, wherein the feed introduces a product consisting essentially of cellulose, water and a functional liquid into the housing, wherein a kneader shaft situated in the housing rotationally mixes and kneads the product and wipes it over heated inner surfaces of the mixing kneader, wherein the amount of undissolved particles in the product and the size of the particles are reduced and some of the water evaporates to form a molding solution,
wherein
the residence time for the product in the mixing kneader is at most 15 minutes.

3. Mixing kneader according to claim 2, wherein the product remains in the mixing kneader for at least two minutes.

4. Mixing kneader according to claim 1, wherein the composition of the transfer mixture is
maximum x_{H2O}=−0.235x_{Cell}+0.235 and
minimum x_{H2O}=−0.59x_{Cell}+0.2047.

5. The mixing kneader according to claim 4, wherein the transfer mixture has a composition of
maximum x_{H2O}=0.2864x²_{CeII}−0.6786x_{CeII}+0.2288
minimum x_{H2O}=0.2864x²_{Cell}−0.6786x_{CeII}+0.2188.

6. Mixing kneader according to claim 1, wherein the transfer mixture passes at least one preceding transfer organ.

7. Mixing kneader according to claim 1, wherein the transfer mixture is produced from a starting material in a preceding process organ.

8. Mixing kneader according to claim 7, wherein a machine control monitors the amount of water, cellulose and functional liquid in the composition of the product in all states up to the molding solution, wherein the machine control monitors the composition of the product in all states up to the molding solution over sensors.

9. Mixing kneader according to claim 7, wherein the preceding process organ is a thin film evaporator.

10. Mixing kneader according to claim 1, wherein the kneader shaft structures of the mixing kneader are designed without heating cavities.

11. Method for processing a transfer mixture to a molding solution according to a direct dissolution method in a mixing kneader with a feed, a housing and a discharge, wherein the feed introduces a product consisting essentially of cellulose, water and a functional liquid from a preceding process organ into the housing, wherein a kneader shaft situated in the housing rotationally mixes and kneads the product and wipes it over heated inner surfaces of the mixing kneader, wherein the amount of undissolved particles in the product and the size of the particles are reduced and some of the water evaporates to form a molding solution, and
wherein
the process volume of the mixing kneader is determined exclusively by the requirements of a molding solution flow capacity.

12. Method according to claim 11, wherein the product remains in the mixing kneader for at most 15 minutes.

13. Method according to claim 11, wherein the product remains in the mixing kneader for at least two minutes.

14. Method according to claim 11, wherein the transfer mixture has the following composition of
maximum x_{H2O}=−0.235x_{CeII}+0.235 and
minimum x_{H2O}=−0.59x_{CeII}+0.2047.

15. The method according to claim 14, wherein the transfer mixture has the following composition of
maximum x_{H2O}=0.2864x²_{CeII}−0.6786x_{CeII}+0.2288
minimum x_{H2O}=0.2864x²_{CeII}−0.6786x_{CeII}+0.2188.
